(19) United States
(12) Patent Application Publication
(10) Pub. No.: US 2025/0291829 A1
(43) Pub. Date: Sep. 18, 2025

(54) METHOD FOR GENERATING RESPONSE TO USER QUERY USING MULTIPLE VECTOR DB COLLECTIONS AND APPARATUS THEREOF

(71) Applicant: SAMSUNG SDS CO., LTD., Seoul (KR)

(72) Inventors: Taeil JUNG, Seoul (KR); Jack SEO, Seoul (KR); Shawn Sungeun KIM, Seoul (KR)

(73) Assignee: SAMSUNG SDS CO., LTD., Seoul (KR)

(21) Appl. No.: 19/075,174

(22) Filed: Mar. 10, 2025

(30) Foreign Application Priority Data
Mar. 12, 2024 (KR) 10-2024-0034627
May 27, 2024 (KR) 10-2024-0068737

(51) Int. Cl. G06F 16/334; G06F 16/332

(52) U.S. Cl. CPC G06F 16/3347; G06F 16/332

(57) ABSTRACT

A processor-implemented method including retrieving information related to a user query for each collection of a vector database, generating a prompt to be input to a large language model (LLM) based on the retrieved information, and acquiring a response to the user query from the LLM using the prompt.

### CROSS-REFERENCE TO RELATED APPLICATION(S)

This application claims the benefit under 35 USC § 119(a) of Korean Patent Application No. 10-2024-0034627 filed on Mar. 12, 2024 and Korean Patent Application No. 10-2024-0068737 filed on May 27, 2024, in the Korean Intellectual Property Office, the entire disclosure of which is incorporated herein by reference for all purposes.

### BACKGROUND OF THE INVENTION

### 1. Field of the invention

The disclosure relates to a technology of generating a response to a user query and, more specifically, to a method for generating a response to a user query by using a retrieval-augmented generation (RAG) based-large language model (LLM), and an apparatus thereof.

### 2. Description of the Prior Art

A large language model (LLM) is a deep-learning model pre-trained on the basis of a massive amount of data. The LIM demonstrates remarkable capabilities, but problems such as hallucinations, slow knowledge updates, and a lack of transparency in responses need to be overcome for actual use. To solve the problems of the LLM, a retrieval-augmented generation (RAG) technology has been proposed.

The RAG is a technology of retrieving related information from a wide-range document set before generating an answer to a question or text in the LLM, and generating a response by using the retrieved related information. This is focused on solving the existing problems of the LLM, such as outdated knowledge, a lack of knowledge in a specific domain, and a lack of transparency in responses. The RAG is helpful in largely enhancing the accuracy of answers, specifically, in reducing hallucinations of the model in knowledge-intensive operations.

However, in the conventional RAG, general information and refined information (e.g., FAQ information, Q&A information, etc.) of a specific domain are not distinguished between each other embedded in a vector database, and thus even useful information is excluded during similarity search and cannot be utilized as a prompt. Accordingly, there is a need for a method for solving problems with the accuracy of information retrieval and LIM responses due to various types of information embedded in the vector database without distinguishment.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including retrieving information related to a user query for each collection of a vector database, generating a prompt to be input to a large language model (LLM) based on the retrieved information, and acquiring a response to the user query from the LIM using the prompt.

The vector database may include multiple collections storing different types of information vectors.

The vector database may include a first collection storing a general information vector, a second collection storing an FAQ/Q&A information vector, and a third collection storing a refined information vector.

The retrieving may include measuring a similarity between user query information of the user query and collection information stored in the first to third collections using a predetermined similarity measurement algorithm and retrieving general information, FAQ/Q&A information, and refined information related to the user query based on the measured similarity.

The vector database may include a first collection storing a general information vector and a second collection storing a refined information vector.

The retrieving may include measuring a similarity between information of the user query and stored information stored in the first and second collections using a predetermined similarity measurement algorithm and retrieving general information and defined information related to the user query based on the measured similarity.

The similarity measurement algorithm may be one of a Euclidean distance algorithm, a cosine similarity algorithm, and a dot product algorithm.

The retrieved information may include one or more of general information and one or more of refined information.

The method may include collecting a similarity of the retrieved information, based on a pre-configured weight for each collection.

The generating of the prompt may include generating the prompt by combining text information of the user query, text information of the retrieved information, information on the collected similarity, and a predetermined system prompt.

The predetermined system prompt may include contents requesting to generate a response in consideration of the collected similarity.

The method may include providing the acquired response to a user terminal originating the user query.

In a general aspect, here is provided a response server including processors configured to execute instructions and a memory storing the instructions, and an execution of the instructions configures the processors to retrieve information related to a user query for each collection of a vector database, generate a prompt to be input to a large language model (LLM) based on the retrieved information, and acquire a response to the user query from the LIM using the prompt.

The vector database may include multiple collections storing different types of information vectors.

The vector database may include a first collection storing a general information vector and a second collection storing a refined information vector.

The retrieving may include measuring a similarity between user query information of the user query and stored information stored in the first and second collections using a predetermined similarity measurement algorithm and retrieving general information and defined information related to the user query based on the measured similarity.

The similarity measurement algorithm may be one of a Euclidean distance algorithm, a cosine similarity algorithm, and a dot product algorithm.

The processors may be further configured to collect a similarity of the retrieved information based on a pre-configured weight for each collection.

The generating of the prompt may include generating the prompt by combining text information of the user query, text information of the retrieved information, information on the collected similarity, and a predetermined system prompt.

In a general aspect, here is provided a computer-readable storage medium storing one or more programs for execution by one or more processors of a computing device, the one or more programs including instructions for retrieving information related to a user query for each collection of a vector database, generating a prompt to be input to a large language model (LLM) based on the retrieved information, and acquiring a response to the user query from the LLM using the prompt.

### BRIEF DESCRIPTION OF THE DRAWINGS

FIG. 1 illustrates a configuration of an AI service provision system according to an embodiment of the disclosure;

FIG. 2 is a block diagram illustrating a configuration of a response server according to an embodiment of the disclosure;

FIGS. 3A and 3B illustrate collections of a vector DB in which different types of information vectors are stored;

FIG. 4 illustrates an operation of an interface unit according to an embodiment of the disclosure;

FIG. 5 illustrates an operation of a configuration unit according to an embodiment of the disclosure;

FIG. 6 illustrates an operation of a configuration information provision unit according to an embodiment of the disclosure;

FIG. 7 illustrates an operation of an information retrieval unit according to an embodiment of the disclosure;

FIGS. 8A and 8B illustrate a method for calibrating similarity of retrieved information on the basis of a weight for each collection;

FIG. 9 illustrates an operation of a prompt generation unit according to an embodiment of the disclosure;

FIG. 10 illustrates an operation of an LLM calling unit according to an embodiment of the disclosure;

FIG. 11 is a flowchart illustrating a response generation method according to an embodiment of the disclosure; and

FIG. 12 is a block diagram illustrating a configuration of a computing device according to an embodiment of the disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means hardware and/or processing hardware configured to implement software processor or computer executable instructions (e.g., as code segment(s), program(s), and/or firmware) to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software executable instructions may include components such as software program components, object-oriented software code or program components, class components, and may include processor task components, processes, functions, attributes, procedures, subroutines, segments of the software code or program. Software Executable instructions may further include programs code, drivers, firmware, microcode, circuits, data, database, data structures, tables, arrays, and variables. In another non-limiting example, such software executable instructions may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Hereinafter, various embodiments of the disclosure are described in detail with reference to the drawings.

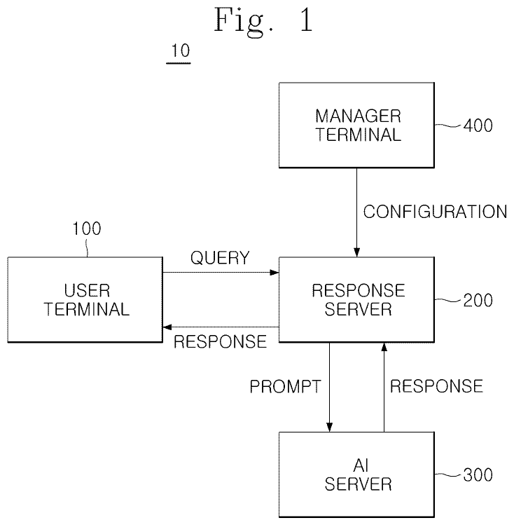

FIG. 1 illustrates a configuration of an AI service provision system according to an embodiment of the disclosure.

Referring to FIG. 1, an AI service provision system 10 according to an embodiment of the disclosure may include a user terminal 100, a response server 200, an AI server 300, and a manger terminal 400.

The user terminal 100 and the response server 200 may be connected to each other through a communication network (not shown). The communication network may include a wired network and a wireless network, and may include, specifically, various networks such as a local area network (LAN), a metropolitan area network (MAN), and a wide area network (WAN). However, the communication network according to the disclosure is not limited to the enumerated networks, and may include at least one of the known wireless data network, the known telephone network, and the known wired/wireless television network.

The user terminal 100 may provide a user with an AI service in association with the response server 200. The AI server may include a chatbot service, a question/answer service, an AI assistant service, etc.

The user terminal 100 may provide the response server 200 with query information input from the user. The user terminal 100 may provide the user with response information received from the response server 200.

The user terminal 100 described in the disclosure may include a mobile phone, a smartphone, a laptop computer, a desktop computer, a digital broadcasting terminal, a personal digital assistant (PDA), a portable multimedia player (PMP), a slate PC, a tablet PC, an ultra-book, a wearable device, and the like, but is not necessarily limited thereto.

The response server 200 may provide a response to a user's query in association with the AI server 300.

The response server 200 may receive the user's query information from the user terminal 100. The response server 200 may retrieve information related to the user's query by using multiple vector DB collections.

The response server 200 may generate a prompt to be input to an LLM by combing the user's query information, the retrieved information related to the user's query, and a pre-defined system prompt. The response server 200 may provide the AI server 300 with the generated prompt.

The response server 200 may receive response information corresponding to the user's query information from the AI server 300. The response server 200 may provide the user terminal 100 with the received response information.

The AI server 300 may provide a pre-constructed large language model (LLM). For the LLM, ChatGPT, Bard, or the like can be used, and the LLM is not necessarily limited thereto.

The AI server 300 may generate response information corresponding to the user's query information on the basis of the prompt received from the response server 200 by using the LLM. The AI server 300 may provide the response server 200 with the generated response information.

Meanwhile, in this embodiment, it is exemplified that the AI server 300 providing the LLM mode is independently constructed outside the response server 200, but the disclosure is not necessarily limited thereto. Accordingly, it will be apparent to those skilled in the art that the AI server 300 can be constructed inside the response server 200.

The manager terminal 400 may access the response server 200 to configure information required to provide the AI service. For example, the manager terminal 400 may configure information required to retrieve information related to a user query. In addition, the manager terminal 400 may configure information required to call the LLM.

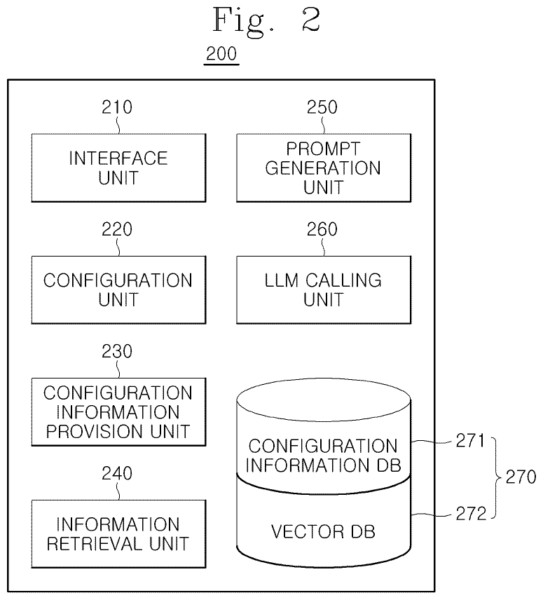

FIG. 2 is a block diagram illustrating a configuration of a response server according to an embodiment of the disclosure.

Referring to FIG. 2, a response server 200 according to an embodiment of the disclosure may include an interface unit 210, a configuration unit 220, a configuration information provision unit 230, an information retrieval unit 240, a prompt generation unit 250, an LLM calling unit 260, and a database 270. Elements illustrated in FIG. 2 are not necessary to implement the response server, and thus the response server described in the disclosure may include more or fewer elements enumerated above.

The interface unit 210 may provide an application programming interface (API) for receiving query information from the user terminal 100.

In addition, the interface unit 210 may provide the API for receiving configuration information from the manager terminal 400.

The interface unit 210 may perform user authentication on the basis of token information received from the user terminal 100. When the user authentication is successfully performed, the response server 200 may provide the user terminal 100 with the AI service.

The interface unit 210 may provide the user terminal 100 with response information received from the LIM calling unit 260.

The configuration unit 220 may configure required to provide the AI service according to a configuration command of the manager terminal 400.

For example, the configuration unit 220 may configure information (hereinafter, referred to as “retrieval configuration information”) required to retrieve information related to the user query. In addition, the configuration unit (220) may configure information (hereinafter, referred to as “call configuration information”) required to call the LLM.

The configuration unit 220 may store information configured through the manager terminal 400 in a configuration information DB 271.

The configuration information provision unit 220 may provide the information retrieval unit 240 with the retrieval configuration information stored in the configuration information DB 271. The configuration information provision unit 220 may provide the LLM calling unit 260 with the call configuration information stored in the configuration information DB 271.

Meanwhile, according to an embodiment of the disclosure, the configuration information provision unit 220 may be configured to be omitted. In this case, the information retrieval unit 240 may directly acquire the retrieval configuration information from the configuration information DB 271. In addition, the LLM calling unit 260 may directly acquire the call configuration information from the configuration information DB 271.

The information retrieval unit 240 may query information stored in the vector DB 272 on the basis of the retrieval configuration information acquired from the configuration information DB 271.

For example, the information retrieval unit 240 may query general information and refined information stored for each collection in the vector DB 272. In another example, the information retrieval unit 240 may query general information, FAQ/Q&A information, and refined information stored for each collection in the vector DB 272.

The information retrieval unit 240 may measure similarity between the user's query information and information stored in the vector DB 272 by using a predetermined similarity measurement algorithm. For the similarity measurement algorithm, a Euclidean distance algorithm, a cosine similarity algorithm, and a dot product algorithm may be used, the similarity measurement algorithm is not necessarily limited thereto. Hereinafter, in this embodiment, for convenience of description, using the Euclidean distance algorithm for the similarity measurement algorithm is provided as an example and described.

The information retrieval unit 240 may retrieve, from the vector DB 272, information related to the user's query on the basis of the measured similarity.

The prompt generation unit 250 may generate a prompt to be input to the LLM mode by combining the user's query information, the retrieved information related to the user's query, and a pre-defined system prompt. The prompt generation unit 250 may provide the LIM calling unit 260 with the generated prompt.

The LLM calling unit 260 may access the AI server 300 on the basis of the call configuration information acquired from the configuration information DB 271 and call the LLM.

The LIM calling unit 260 may provide the AI server 300 with the prompt received from the prompt generation unit 250. The AI server 300 may generate response information corresponding to the user's query information on the basis of the prompt received from the LLM calling unit 260 by using the LLM. The AI server 300 may provide the LLM calling unit 260 with the generated response information.

The LIM calling unit 260 may receive the response information corresponding to the user's query information from the AI server 300. The LLM calling unit 260 may provide the interface unit 210 with the received response information.

The database 270 may include the configuration information DB 271 and the vector DB 272.

The configuration information DB 271 may store information configured through the manager terminal 400. For example, the configuration information DB 271 may store information required to retrieve information (i.e., retrieval configuration information) related to a user query and information (i.e., call configuration information) required to call the LLM.

The configuration information DB 271 may store information configured by default. The information configured by default may be used when there is no information configured by a manager.

The vector DB 272 may embed information related to a service domain and store the same in a vector form.

The vector DB 272 may include multiple collections storing various types of information vectors.

Here, a collection means a space for storing an embedded information vector.

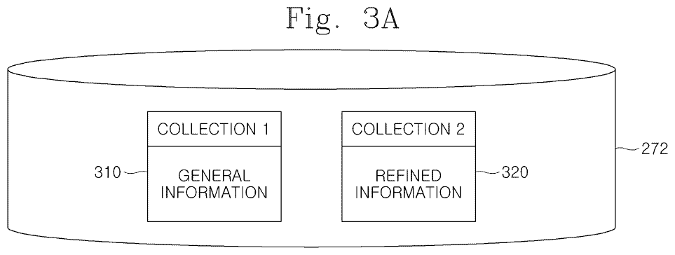

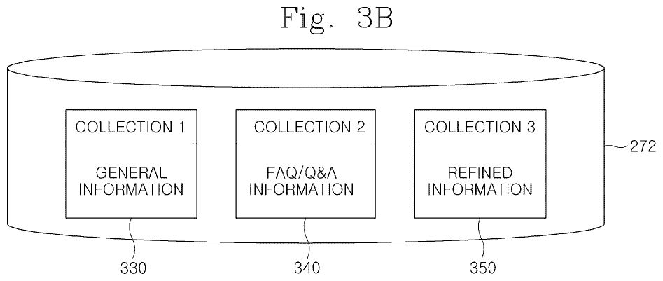

For example, as illustrated in FIG. 3A, the vector DB 272 may include a first collection 310 storing a vector in which general information related to a service domain is embedded, and a second collection 320 storing a vector in which refined information related to a service domain is embedded. Here, the refined information means information processed in a form suitable for responding to the user's query.

In another example, as illustrated in FIG. 3B, the vector DB 272 may include a first collection 330 storing a vector in which general information related to a service domain is embedded, a second collection 340 storing a vector in which FAQ/Q&A information related to a service domain is embedded, a third collection 350 storing a vector in which refined information related to a service domain is embedded. Here, the refined information corresponds to a higher concept including FAQ/Q&A information. Accordingly, when three collections are included, it is preferrable not include the FAQ/Q&A information in the refined information. Hereinafter, in this embodiment, for convenience of description, a vector DB including three collections is exemplified and described.

As described above, the response server according to an embodiment of the disclosure may utilize multiple vector DB collections to retrieve general information and refined information related to the user's query, thereby enhancing accuracy of an LLM response by using the retrieved information.

Hereinafter, operations of elements included in the response server 200 according to the disclosure are described in more detail.

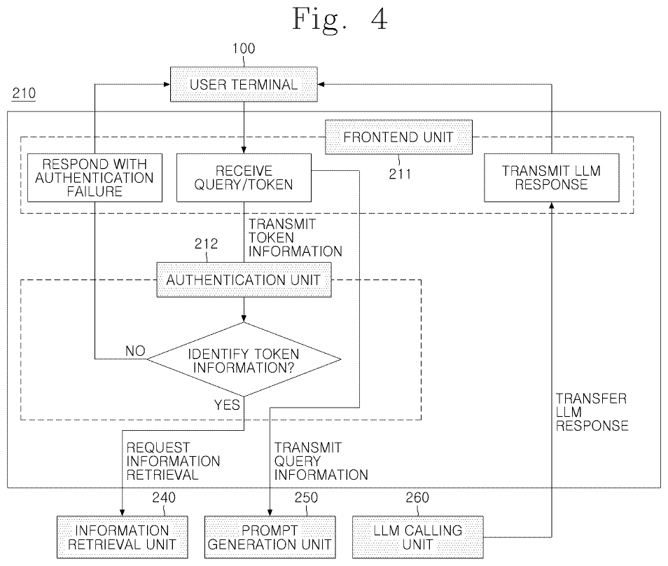

FIG. 4 illustrates an operation of an interface unit according to an embodiment of the disclosure.

Referring to FIG. 4, the interface unit 210 according to an embodiment of the disclosure may include a frontend unit 211 and an authentication unit 212.

The frontend unit 211 may provide an API for receiving query information from a user terminal 100. The frontend unit 211 may acquire query information and token information of the user from the user terminal 100 through the API.

The frontend unit 211 may provide a prompt generation unit 250 with the user's query information. The frontend unit 211 may provide the authentication unit 212 with the token information of the user.

The frontend unit 211 may acquire a response to the user query from an LLM calling unit 260. The frontend unit 211 may provide the user terminal 100 with the acquired response.

Although not shown, the frontend unit 211 may provide an API for receiving configuration information from a manager terminal 400. The frontend unit 211 may acquire a manager's configuration from the manager terminal 400 through the API.

The authentication unit 212 may perform user authentication on the basis of the token information received from the frontend unit 211. When the user authentication is successfully performed, the authentication unit 212 may request information retrieval related to the user query from the information retrieval unit 240. When the user authentication fails to be performed, the authentication unit 212 may transmit an authentication failure message to the user terminal 100 through the frontend unit 211.

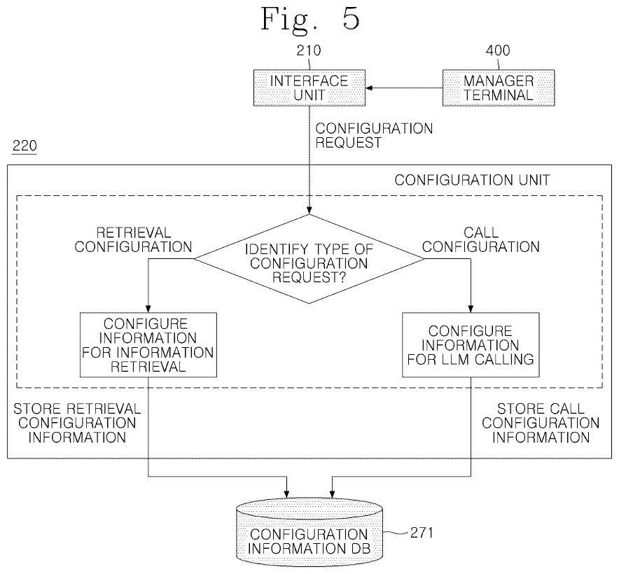

FIG. 5 illustrates an operation of a configuration unit according to an embodiment of the disclosure.

Referring to FIG. 5, a configuration unit 220 according to an embodiment of the disclosure may identify whether a configuration request is input from a manager terminal 400.

As a result of the identification, when a configuration request is input from the manager terminal 400, the configuration unit 220 may identify the type of the configuration request. That is, the configuration unit 220 may identify whether the configuration request is a configuration request for information retrieval or a configuration request for LLM calling.

As a result of the identification, when the configuration request is a configuration request for information retrieval, the configuration unit 220 may configure information (i.e., retrieval configuration information) required to retrieve information related to the user's query according to a configuration command of the manager. The retrieval configuration information may include the number of collections, the number of information selections for each collection, weight information for each collection, and the like.

As a result of the identification, when the configuration request is the configuration request for LLM calling, the configuration unit 220 may configure information (i.e., call configuration information) required to call the LLM according to the configuration command of the manager. The call configuration information may include LLM call attribute information.

The configuration unit 220 may store, in the configuration information DB 471, the retrieval configuration information and/or the call configuration information configured through the manager.

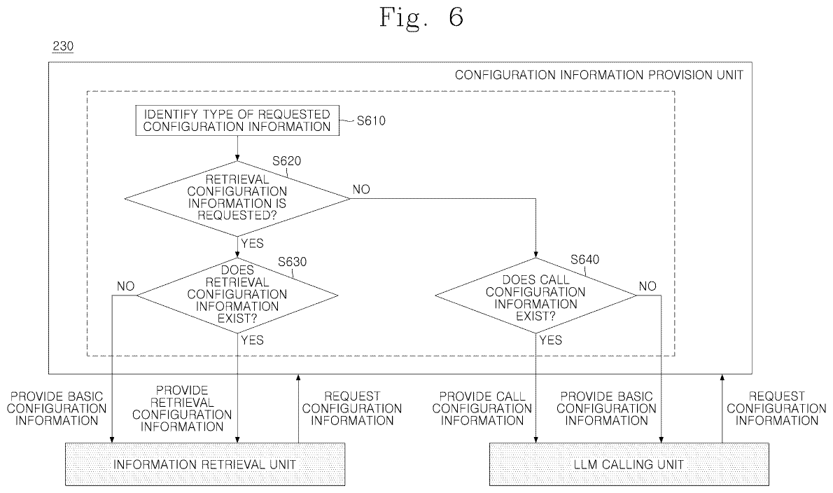

FIG. 6 illustrates an operation of a configuration information provision unit according to an embodiment of the disclosure.

Referring to FIG. 6, the configuration information provision unit 230 according to an embodiment of the disclosure may receive a configuration information request message from an information retrieval unit 240 or an LLM calling unit 260.

The configuration information provision unit 230 may identify whether the requested configuration information is retrieval configuration information or call configuration information (S610).

As a result of the identification in operation 610, when the requested configuration information is the retrieval configuration information (S620), the configuration information provision unit 230 may identify whether the retrieval configuration information configured by the manager exists in the configuration information DB 471 (S630).

As a result of the identification in operation 630, when the retrieval configuration information configured by the manager exists, the configuration information provision unit 230 may provide the information retrieval unit 240 with the retrieval configuration information. As a result of the identification in operation 630, when the retrieval configuration information configured by the manager does not exist, the configuration information provision unit 230 may provide the information retrieval unit 240 with information configured by default (i.e., basic configuration information).

As a result of the identification in operation 610, when the request configuration information is call configuration information (S620), the configuration information provision unit 230 may identify whether the call configuration information configured by the manager exists in the configuration information DB 471 (S640).

As a result of the identification in operation 640, when the call configuration information configured by the manager exists, the configuration information provision unit 230 may provide the LLM calling unit 260 with the call configuration information. As a result of the identification in operation 640, when the call configuration information configured by the manager does not exist, the configuration information provision unit 230 may provide the LIM calling unit 260 with information configured by default (i.e., basic configuration information).

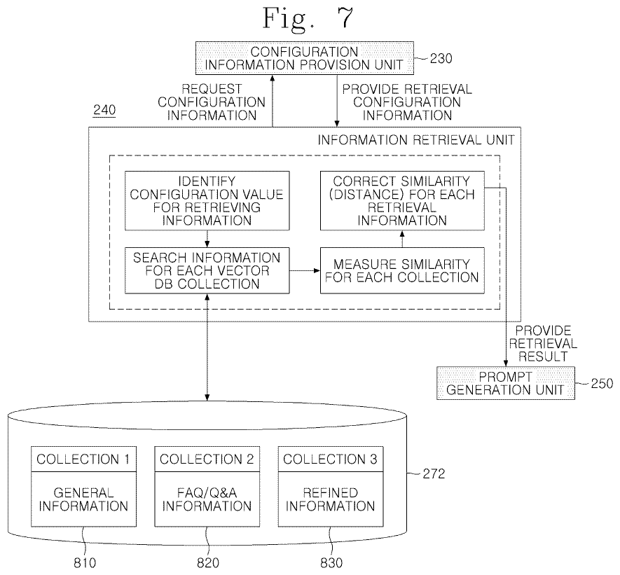

FIG. 7 illustrates an operation of an information retrieval unit according to an embodiment of the disclosure.

Referring to FIG. 7, an information retrieval unit 240 according to an embodiment of the disclosure may identify a configuration value for information retrieval on the basis of the retrieval configuration information acquired from a configuration information DB 271.

The information retrieval unit 240 may retrieve, from a vector DB 272, information related to a user's query on the basis of the identified configuration value.

More specifically, the information retrieval unit 240 may query information for each collection of the vector DB 272. For example, the information retrieval unit 240 may subsequently query general information stored in a first collection of the vector DB 272, FAQ/Q&A information stored in a second collection, and refined information stored in a third collection.

The information retrieval unit 240 may measure similarity between the user's query information and information stored in the vector DB 272 by using a predetermined similarity measurement algorithm. In this case, the information retrieval unit 240 may measure similarity for each collection of the vector DB 272.

When the Euclidean distance algorithm for the similarity measurement algorithm, the similarity between two vectors may be represented by distance information. Accordingly, the shorter the distance between two vectors, the similarity between to vectors is increased.

The information retrieval unit 240 may retrieve information related to a user query on the basis of the measured similarity. In this case, the information retrieval unit 240 may retrieve the information related to the user query for each collection of the vector DB 272.

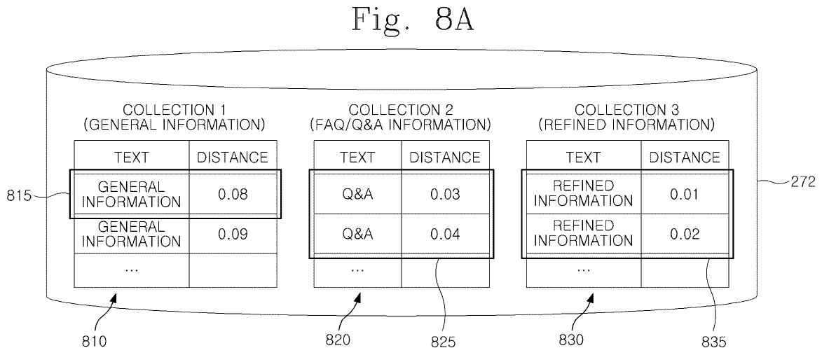

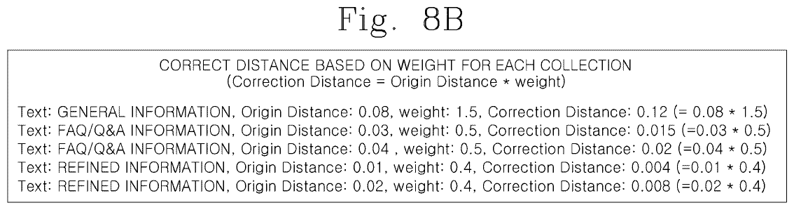

As illustrated in FIG. 8A, when the number of information selections of the first collection 810 is configured as 1, the information retrieval unit 240 may retrieve one piece of general information 815 that is most similar to the user query from the first collection 810 on the basis of the measured similarity. When the number of information selections of the second collection 820 is configures as 2, the information retrieval unit 240 may retrieve two pieces of FAQ/Q&A information 825 that are most similar to the user query from the second collection 820 on the basis of the measured similarity. When the number of information selections of the third collection 830 is configured as 2, the information retrieval unit 240 may retrieve two pieces of refined information 835 that are most similar to the user query from the third collection 830 on the basis of the measured similarity.

The information retrieval unit 240 may correct the similarity (i.e., distance) of the retrieved information on the basis of a pre-configured weight for each collection. This is for reducing an error according to a distance difference calculated from collections having different qualities of information by assigning a lower weight to the general information and assigning a higher weight to the FAQ/Q&A information and refined information.

For example, as illustrated in FIG. 8B, when the distance for the retrieved general information is 0.08 and the weight of the first collection is 1.5, the information retrieval unit 240 may correct the original distance value multiplying the distance value of the general information and the weight value. Similarly, when the distance for the retrieved FAQ/Q&A information is 0.03 and the weight of the second collection is 0.5, the information retrieval unit 240 may correct the original distance value by multiplying the distance value of the FAQ/Q&A information and the weight value. In addition, when the distance for the retrieved defined information is 0.01 and the weight of the third collection is 0.4, the information retrieval unit 240 may correct the original distance value by multiplying the distance value of the refined information and the weight value.

The information retrieval unit 240 may provide the prompt generation unit 250 with general information (text), FAQ/Q&A information (text), and refined information (text) related to the user query and collected similarity information of each piece of text information.

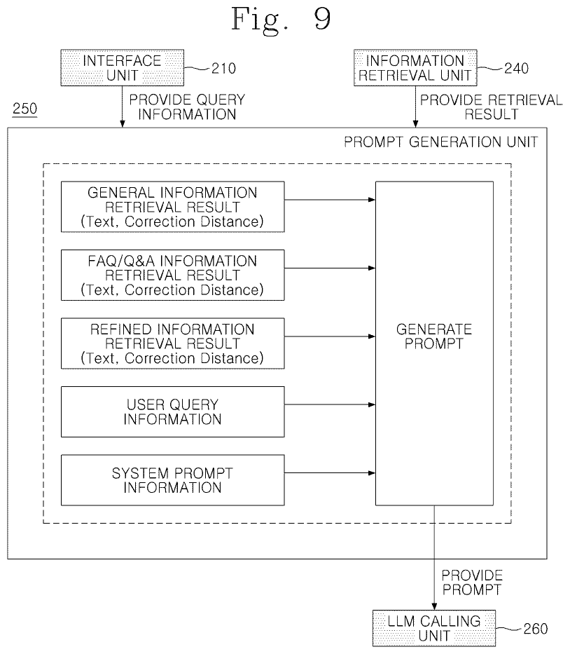

FIG. 9 illustrates an operation of a prompt generation unit according to an embodiment of the disclosure.

Referring to FIG. 9, a prompt generation unit 250 according to an embodiment of the disclosure may acquire a user's query information from an interface unit 210.

The prompt generation unit 250 may acquire a retrieval result related to the user query from an information retrieval unit 240. In this case, the retrieval result may include text information relating to general information, text information relating to FAQ/Q&A information, text information relating to refined information, and collected similarity information of each piece of text information.

The prompt generation unit 250 may generate a prompt to be input to an LIM by combining the general information retrieval result, the FAQ/Q&A information retrieval result, the refined information retrieval result, the text information relating to the user query, and a pre-defined system prompt. Here, the system prompt may include contents prompting generation of a response in consideration of corrected similarity.

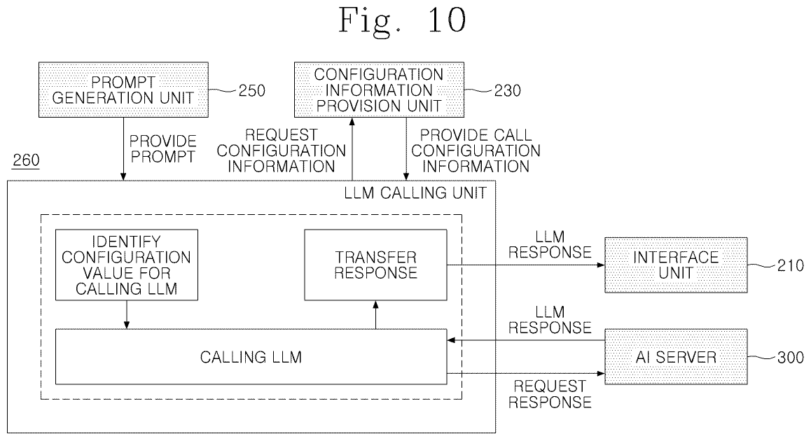

FIG. 10 illustrates an operation of an LLM calling unit according to an embodiment of the disclosure.

Referring to FIG. 10, an LLM calling unit 260 may identify a configuration value for calling an LIM on the basis of call configuration information acquired from a configuration information DB 271.

The LLM calling unit 260 may access an AI server 300 on the basis of the identified configuration value and call the LLM.

The LIM calling unit 260 may acquire a prompt to be input to the LLM from a prompt generation unit 250.

The LLM calling unit 260 may transmit a response request message including the prompt to an AI server 300. The AI server 300 may generate a response related to the user's query by using the LLM. The AI server 300 may provide the LLM calling unit 260 with the generated LLM response.

The LLM calling unit 260 may receive the LLM response from the AI server 300. The LLM calling unit 260 may provide the interface unit 210 with the received LLM response.

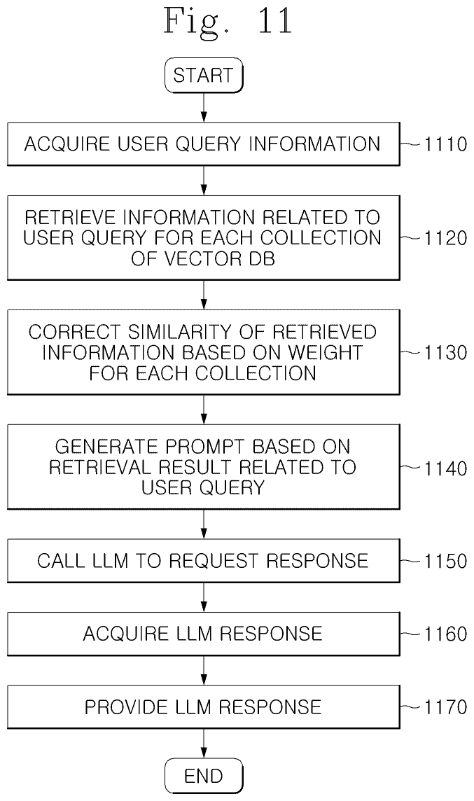

FIG. 11 is a flowchart illustrating a response generation method according to an embodiment of the disclosure. The response generation method according to this embodiment may be performed by a response server 200. The response generation method in the illustrated flowchart is divided into multiple operations and described, but at least some operations may be reordered and performed, may be combined with other operations and performed together, may be omitted, or divided into detailed operations and performed, or one or more unillustrated operations may be added and performed.

Referring to FIG. 11, the response server 200 according to the disclosure may acquire a user's query information from a user terminal 100 (S1100).

The response server 200 may retrieve information related to a user query for each collection of a vector DB 272 (S1120). In this case, the response server 200 may measure similarity between the user's query information and information stored in each collection by using a predetermined similarity measurement algorithm. The response server 200 may retrieve general information, FAQ/Q&A information, and refined information related to the user's query on the basis of the measured similarity.

The response server 200 may collect similarity of retrieved information on the basis of a weight for each collection. This is for reducing an error according to a distance difference calculated from collections having different qualities of information by assigning a lower weight to the general information and assigning a higher weight to the FAQ/Q&A information and refined information.

The response server 200 may generate a prompt to be input to an LLM by combining text information relating to the user query, a retrieval result related to the user's query, and a system prompt (S1140). Here, the retrieval result may include text information relating to general information, text information relating to FAQ/Q&A information, text information relating to refined information, and collected similarity information of each piece of text information.

The response server 200 may access an AI server 300 to call the LIM, and may request a response to the user query from the called LLM (S1150). In this case, the response server 200 may provide the LLM with the prompt.

The response server 200 may acquire the LLM response from the LLM of the AI server 300 (S1160).

The response server 200 may provide the user terminal 100 with the acquired LLM response (S1170).

As described above, the response generation method according to an embodiment of the disclosure may utilize multiple vector DB collections to retrieve general information and refined information related to the user's query, thereby enhancing accuracy of an LLM response by using the retrieved information.

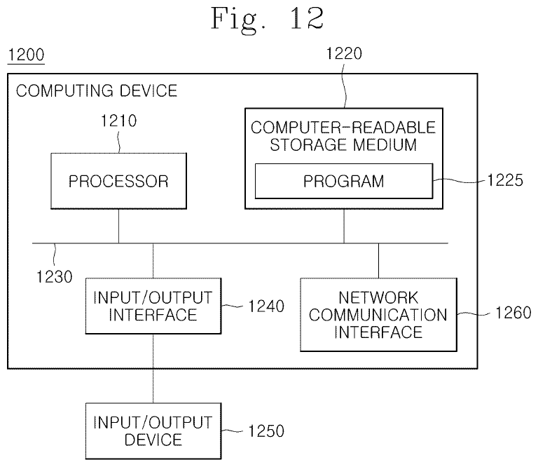

FIG. 12 is a block diagram illustrating a configuration of a computing device according to an embodiment of the disclosure.

Referring to FIG. 12, a computing device 1200 according to an embodiment of the disclosure may include at least one processor 1210, a computer-readable storage medium 1220, a communication bus 1230. The computing device 1200 may implement the above-described response server 200, or may implement elements 210 to 270 constituting the response server 200.

The processor 1210 may cause the computing device 1200 to operate according to the above-described exemplary embodiment. For example, the processor 1210 may execute one or more programs 1225 stored in the computer-readable storage medium 1220. The one or more programs may include one or more computer-executable instructions, and when the computer-executable instructions are executed by the processor 1210, the processor may be configured to cause the computing device 1200 to perform operations according to the exemplary embodiment.

The computer-readable storage medium 1220 is configured to store a computer-executable instruction or program code, program data, and/or other appropriate type of information. The program 1225 stored in the computer-readable storage medium 1220 includes a set of instructions executable by the processor 1210. In an embodiment, the computer-readable storage medium 1220 may be memory (volatile memory such as random access memory, non-volatile memory, or an appropriate combination thereof), one or more magnetic disk storage devices, optical disk storage devices, flash memory devices, other types of storage media which can be accessed by the computing device 1200 and store desired information, or an appropriate combination thereof.

The communication bus 1230 may connect different components of the computing device 1200, including the processor 1210 and the computer-readable storage medium 1220.

The computing device 1200 may also include one or more input/output interfaces 1240 for providing an interface for one or more input/output devices 1250, and one or more network communication interfaces 1260. The input/output interface 1240 and the network communication interface 1260 are connected to the communication bus 1230.

The input/output device 1250 may be connected to other components of the computing device 1200 through the input/output interface 1240. The illustrative input/output device 1250 may include a pointing device (a mouse, a track pad, etc.), a keyboard, a touch input device (a touch pad, a touch screen, etc.), a voice or sound input device, an input device such as various types of sensor devices and/or photographing devices, and/or an output device such as a display device, a printer, a speaker, and/or a network card. The illustrative input/output device 1250 may be included in the computing device 1200 as a component constituting the computing device 1200, or may be connected to the computing device 1200, as a separate device distinguished from the computing device 1200.

The advantageous effects of a response generation method using multiple vector DB collections and an apparatus thereof according to embodiments of the disclosure are as follows.

According to at least one of the embodiments of the disclosure, similarity between information on a user query and information stored in multiple vector DB collections can be measured, and information related to the user query can be more accurately retrieved on the basis of the measured similarity.

In addition, according to at least one of the embodiments of the disclosure, generation information and refined information related to a user query are retrieved using multiple vector DB collections, and accuracy of an LLM response can be enhanced using the retrieved information.

However, the advantageous effects which can be achieved by the response generation method using multiple vector DB collections and the apparatus thereof according to embodiments of the disclosure are not limited to the above-mentioned effects, and other unmentioned effects can be apparently understood by those skilled in the art to which the disclosure belongs from the description below.

The computing devices, processors, memories, modules, units, systems, apparatuses, neural networks, servers, terminals, databases, AI service provision system 10, user terminal 100, response server 200, AI server 300, manger terminal 400, interface unit 210, frontend unit 211, authentication unit 212, configuration unit 220, configuration information provision unit 230, information retrieval unit 240, prompt generation unit 250, LLM calling unit 260, database 270, computing device 1200, at least one processor 1210, computer-readable storage medium 1220, communication bus 1230, and interfaces 1240, 1250, and 1260 described herein and disclosed herein described with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMS, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
retrieving information related to a user query for each collection of a vector database;
generating a prompt to be input to a large language model (LLM) based on the retrieved information; and
acquiring a response to the user query from the LLM using the prompt.

2. The method of claim 1, wherein the vector database comprises multiple collections storing different types of information vectors.

3. The method of claim 2, wherein the vector database further comprises a first collection storing a general information vector, a second collection storing an FAQ/Q&A information vector, and a third collection storing a refined information vector.

4. The method of claim 3, wherein the retrieving comprises:
measuring a similarity between user query information of the user query and collection information stored in the first to third collections using a predetermined similarity measurement algorithm; and
retrieving general information, FAQ/Q&A information, and refined information related to the user query based on the measured similarity.

5. The method of claim 2, wherein the vector database further comprises a first collection storing a general information vector and a second collection storing a refined information vector.

6. The method of claim 5, wherein the retrieving comprises:
measuring a similarity between user information of the user query and stored information stored in the first and second collections using a predetermined similarity measurement algorithm; and
retrieving general information and defined information related to the user query based on the measured similarity.

7. The method of claim 4, wherein the similarity measurement algorithm is one of a Euclidean distance algorithm, a cosine similarity algorithm, and a dot product algorithm.

8. The method of claim 1, wherein the retrieved information comprises one or more of general information and one or more of refined information.

9. The method of claim 8, further comprising:
collecting a similarity of the retrieved information, based on a pre-configured weight for each collection.

10. The method of claim 9, wherein the generating of the prompt comprises:
generating the prompt by combining text information of the user query, text information of the retrieved information, information on the collected similarity, and a predetermined system prompt.

11. The method of claim 10, wherein the predetermined system prompt comprises contents requesting to generate a response in consideration of the collected similarity.

12. The method of claim 1, further comprising providing the acquired response to a user terminal originating the user query.

13. A response server, the server comprising:
processors configured to execute instructions; and
a memory storing the instructions, wherein execution of the instructions configures the processors to:
retrieve information related to a user query for each collection of a vector database;
generate a prompt to be input to a large language model (LLM) based on the retrieved information; and
acquire a response to the user query from the LLM using the prompt.

14. The server of claim 13, wherein the vector database comprises multiple collections storing different types of information vectors.

15. The server of claim 14, wherein the vector database further comprises a first collection storing a general information vector and a second collection storing a refined information vector.

16. The server of claim 15, wherein the retrieving comprises:
measuring a similarity between user query information of the user query and stored information stored in the first and second collections using a predetermined similarity measurement algorithm; and
retrieving general information and defined information related to the user query based on the measured similarity.

17. The server of claim 16, wherein the similarity measurement algorithm is one of a Euclidean distance algorithm, a cosine similarity algorithm, and a dot product algorithm.

18. The server of claim 13, wherein the processors are further configured to:
collect a similarity of the retrieved information based on a pre-configured weight for each collection.

19. The server of claim 18, wherein the generating of the prompt comprises:
generating the prompt by combining text information of the user query, text information of the retrieved information, information on the collected similarity, and a predetermined system prompt.

20. A computer-readable storage medium storing one or more programs for execution by one or more processors of a computing device, the one or more programs comprising instructions for:
retrieving information related to a user query for each collection of a vector database;
generating a prompt to be input to a large language model (LLM) based on the retrieved information; and
acquiring a response to the user query from the LLM using the prompt.
